(19) United States
(12) Patent Application Publication
(10) Pub. No.: US 2015/0032640 A1
(43) Pub. Date: Jan. 29, 2015

(54) SYSTEM AND METHOD OF PROVIDING PERSONALIZED DEALERSHIP SERVICE

(71) Applicant: Ford Global Technologies, LLC, Dearborn, MI (US)

(72) Inventors: Chad Evert Esselink, Canton, MI (US); Jeffrey Lee Hentschel, Novi, MI (US); Chad Christopher Boes, Plymouth, MI (US); Andrew Shaffer, Bloomfield Village, MI (US)

(73) Assignee: Ford Global Technologies, LLC, Dearborn, MI (US)

(21) Appl. No.: 13/948,415

(22) Filed: Jul. 23, 2013

(51) Int. Cl. G06Q 30/00

(52) U.S. Cl. CPC G06Q 30/016
USPC 705/304

(57) ABSTRACT

A method includes managing a customer database for an automobile dealership, identifying a customer in the database when a vehicle of the customer enters in proximity of the automobile dealership, and providing information to the customer that is personalized to the customer.

### BACKGROUND

For auto sales and service, dealerships desire to provide the best possible care to the customer so that the customer is satisfied and will return in the future. However, when a customer arrives at the dealership, the customer may not know where to park, where to go, or whom to talk to. Likewise, when the customer arrives at the dealership, because the sales and service personnel may not recognize the customer, ascertaining the customer's intent and getting them in touch with the right person can be time-consuming, random, and may appear chaotic. Oftentimes a dealership will have a receptionist present to ask questions of, but many dealerships have such large facilities that the customer may not even encounter the receptionist. It would therefore be of interest to make customers immediately feel welcomed upon arrival at a dealership and readily give personalized services that are tailored to their specific needs.

### SUMMARY

A method includes managing a customer database for an automobile dealership, identifying a customer in the database when a vehicle of the customer enters in proximity of the automobile dealership, and providing information to the customer that is personalized to the customer.

A system for managing an automobile dealership customer relationship includes a customer database and a computer programmed to identify a vehicle when the vehicle enters in proximity to a dealership, access the database and identify a customer that is affiliated with the identified vehicle, and send information to a computer within the vehicle that is personalized to the customer.

An automobile dealership includes a facility that provides automobile dealership services, a customer database, and a computer programmed to identify a vehicle when it enters in proximity to the facility, access the database and identify a customer that is affiliated with the vehicle, and send information to a computer within the vehicle that is personalized to the customer.

### BRIEF DESCRIPTION OF THE DRAWINGS

FIG. 1 illustrates a vehicle that includes features that are incorporated into the disclosed system and method;

FIG. 2 illustrates a dashboard of a vehicle;

FIG. 3 illustrates a vehicle dealership that incorporates elements of the disclosed material;

FIG. 4 illustrates a method of providing personalized dealership service; and

FIG. 5 illustrates a schematic representation of a system for providing personalized dealership service.

### DETAILED DESCRIPTION

The illustrative embodiments include a dealership and a system and method for providing personalized dealership service to new and return customers.

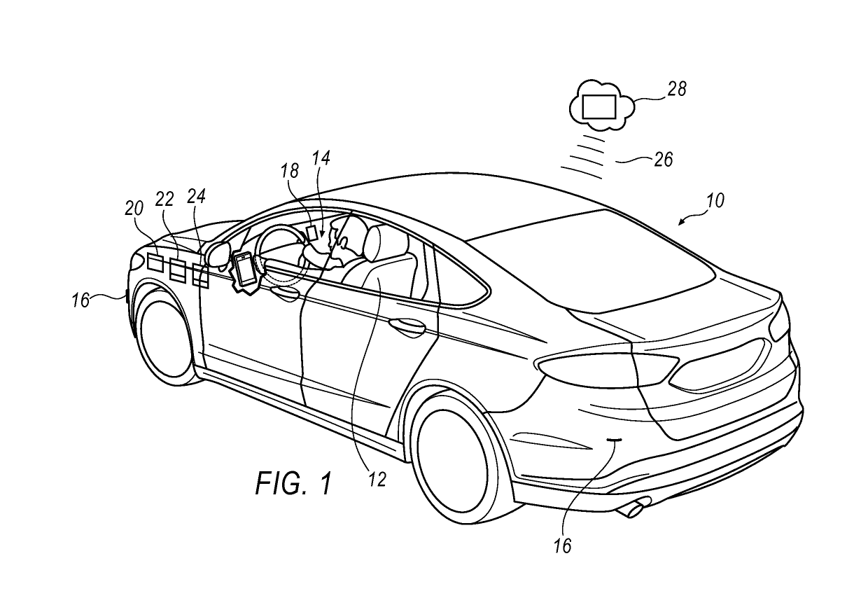

FIG. 1 shows a vehicle 10 having features that are incorporated into the disclosed system and method. Vehicle 10 is illustrated as a typical 4-door sedan, but may be any vehicle for driving on a road, such as a compact car, a pickup truck, or a semi-trailer truck, as examples. Vehicle 10 includes a seat 12 for positioning a driver. Vehicle 10 includes a dashboard 14 that typically includes control buttons or switches for activating various devices on vehicle 10. A steering wheel is positioned such that the driver can steer vehicle 10 while driving.

Vehicle 10 includes a number of features, which include but are not limited to an airbag system, various sensors 16 throughout vehicle 10, an audio/visual system 18, a GPS 20, and a communication system 22 that includes but is not limited to a WiFi system, an embedded modem, and a dedicated short-range communication (DSRC) system. A DSRC uses one-way or two-way short- to medium-range wireless communication channels specifically designed for automotive use and a corresponding set of protocols and standards. A computer or computing device 24 is positioned within vehicle 10, which provides any number of features that include controlling engine and other vehicle parameters, monitoring vehicle operation (safety devices, tire pressure, etc. . . . ), interfacing with the driver via the audio/visual system 18, monitoring vehicle position via GPS 20, providing map and directions to the driver using GPS information, to name a few. The audio and/or visual device 18 may provide warning to a driver or other occupant of a car of a hazard, for instance, may inform the driver of driving instructions, or may provide other features.

Communication system 22 is configured to operate wirelessly with systems external to vehicle 10. In one embodiment, signals are sent wirelessly 26 external to the vehicle, such as to a “cloud computing” device or collection of computers or computing devices 28. Signals may also be sent from communication system 22 via the WiFi system, the embedded modem, or DSRC to other devices external to the vehicle, such as to an automobile dealership computer. In one embodiment, computer interaction is with a computing system that is accessible to the internet that is not on-site at an automobile dealership. In this embodiment, the server is not required to be on-site at the dealership but may be maintained as, for instance, a regional database that resides at a central computer facility and is accessible to other or multiple dealerships as well.

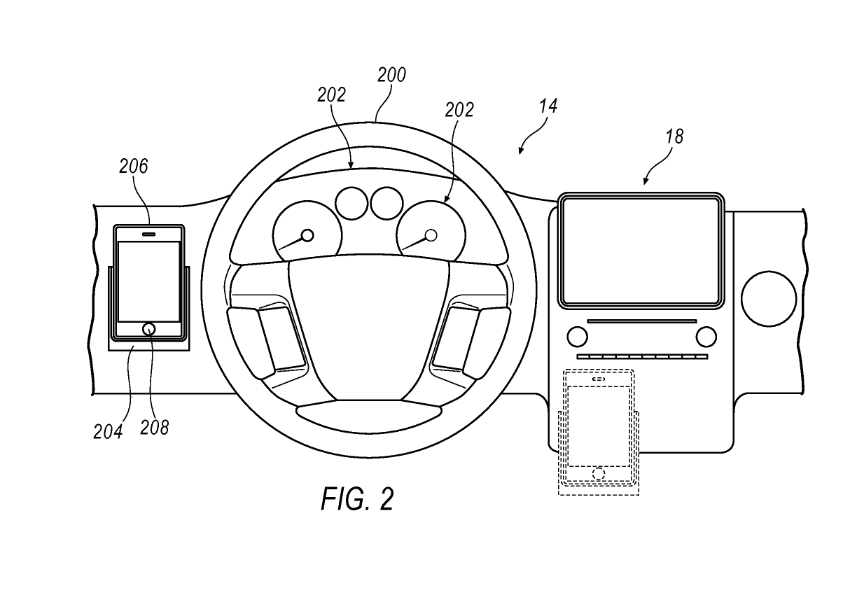

Referring to FIG. 2, dashboard 14 includes a steering wheel 200 and instruments 202 that display vehicle speed, engine speed (e.g., in a tachometer), and the like. Dashboard 14 includes a holder 204 to which a cellphone or cellular telephone 206 is attached. Holder 204 includes any device for holding cellphone 206, such as a clamping device, Velcro, or a device with slots into which cellphone 206 slides, as examples. In an alternative embodiment, holder 204 is not provided and cellphone 206 may be simply placed in the vehicle next to the driver.

In addition to conventional cellphone communication capability (e.g., for telephone calls) cellphone 206 includes a wireless communication device such as Bluetooth or other known methods for communicating with a local device such as computing device 24 of vehicle 10. Such may be useful for sending music or other information for use on a sound system of vehicle 10, or for communicating with a safety system of vehicle 10, as examples.

Cellphone 206 in one embodiment is a “smartphone” that is capable of executing software applications, or “apps” that interact with the internet via a touchscreen or other known methods. Cellphone 206 includes a camera 208 and at least one of a keypad and display. As such, a driver or other occupant of the vehicle may communicate wirelessly with computers that are external to the vehicle using computing device 24 and interfacing therewith by using an “app” on cellphone 206, and/or by using audio/visual system 18. Such communication may be with an icon-driven touchscreen, voice-recognition, or by using a text feature, as examples, and touchscreen or voice-recognition may be preferred to prevent a driver from performing an unsafe activity such as texting while driving. Communication may be via computing device 24 to computing devices 28 or to another computer, such as a computer at an automobile dealership.

That is, an occupant of a vehicle may communicate with computers external to the vehicle via any number of means, including but not limited to a cell phone and/or via a communication system that is part of the vehicle and may be incorporated into a dashboard thereof. Communication is wireless and two-way and may include cloud computing devices and/or a computer device affiliated with a business or industry, such as an automobile dealership.

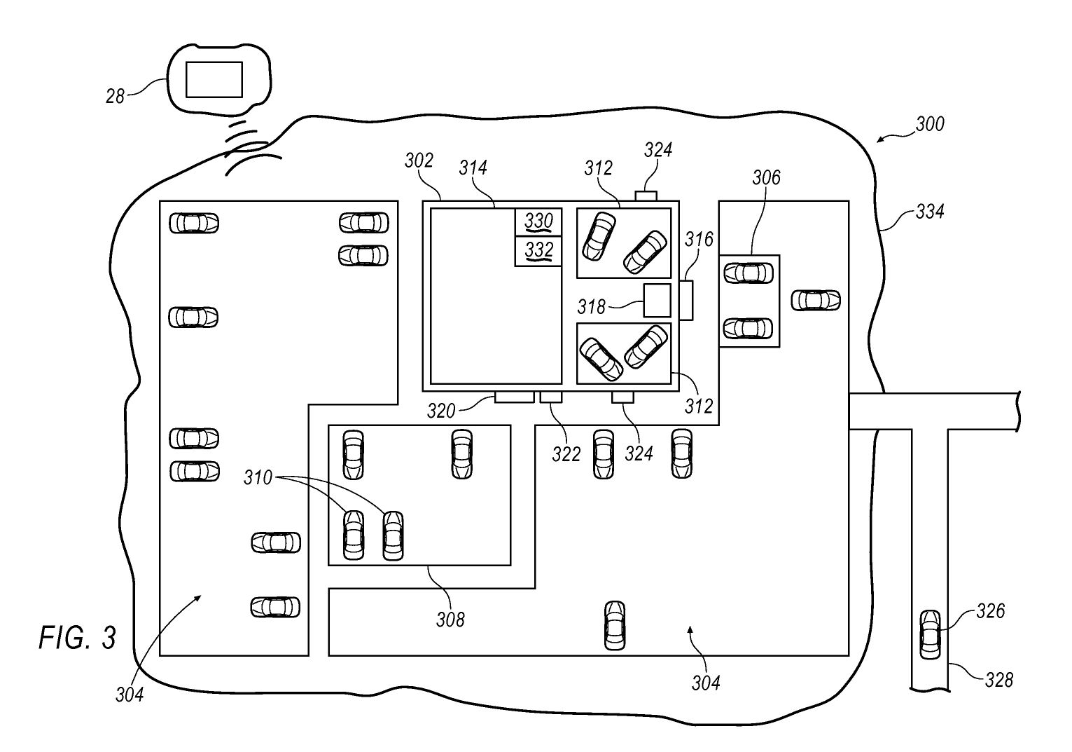

Referring to FIG. 3, an automobile dealership 300 includes a facility 302 that provides automobile dealership services. In the embodiment illustrated, dealership 300 includes outdoor parking 304 for new or used vehicles that are on display and are for sale. Dealership 300 includes outdoor parking 306 that is designated for customer use that may be drive-up customers interested in purchasing a vehicle. Dealership 300 also includes outdoor parking 308 that is designated for customer use as it relates to customers having their vehicle serviced. Further, some dealerships include some or all of their parking as indoor parking. As such, some or all of lots 304, 306, and 308 may be indoor structures. Parking 308 may include parking spots for dropping off a vehicle for service, and may also include vehicles 310 that may be replacement vehicles that are available for customer use during the period when their vehicle is being serviced.

Facility 302 may include a vehicle showroom 312 in which vehicles may be displayed indoors, and a service area 314 where mechanics are stationed for repairing or maintaining vehicles that have been dropped off by customers. Facility 302 includes a main entrance 316 that is proximate parking 306 and also proximate a receptionist area 318. Facility 302 also includes a service entrance 320 that is proximate parking 308, and a “drop box” 322 proximate the service entrance where keys can be securely placed if a customer is dropping off a vehicle for repair after business hours. Facility 302 also includes side entrances 324. A vehicle 326 enters the area of dealership 300 using a road 328.

Facility 302 also includes a computer or computing device 330 that accesses a customer database 332. Computer 330 also includes the ability to wirelessly communicate with computers that are external to dealership 300, such as to computing devices 28 as described with respect to FIG. 1, and/or computing devices such as computing device 24 of vehicle 10 of FIG. 1 (via the WiFi system, the embedded modem, or the DSRC of vehicle 10).

Computer 330 is programmed to identify a vehicle, such as vehicle 326, when it enters in proximity to facility 302. Typically, according to disclosed embodiments, dealership 300 includes an approximate boundary 334 that represents a distance beyond which vehicles are not considered to be in proximity thereto. Distance from facility 302 to boundary 334 may be range from 100 meters to 1 kilometer, as examples, but may in fact be any distance at which the vehicle may be wirelessly detected. The distance to boundary 334 may be established based on traffic patterns, nearby roads, and the like, such that when vehicles enter onto road 328, it can be surmised that they are likely headed to dealership 300. As such, the distance is considered approximate and may be fixed to be a specific distance based on individual circumstances, but may be a fixed distance from the dealership that is delineated by boundary 334 that surrounds dealership 300.

Further, vehicles external to boundary 334 may nevertheless be detected by computer 330 by communicating directly with communication system 22 (or the vehicle computer system itself may detect when it is within proximity of the dealership), but if the vehicles do not actually enter a portion of the road headed toward facility 302, the computer may disregard the vehicle. That is, once computer 330 establishes communication between vehicle 326 and the dealership, the distance and assessment of whether it is in close proximity can be determined by obtaining a position of the vehicle via a global positioning system (GPS), such as GPS 20 of vehicle 10, that is positioned in vehicle 326. In another embodiment, the computer on the vehicle determines proximity of vehicle 326 with respect to dealership 300 based on its GPS coordinates, and controls interaction with dealership computer 330 based on whether vehicle 326 is within proximity of the dealership 300.

Once vehicle 326 crosses boundary 334, as determined from its GPS location, computer 330 is further programmed to access database 332 and identify a customer that is affiliated with vehicle 326. In one embodiment, computer 330 identifies when vehicle 326 crosses the boundary only after being triggered by vehicle 326 itself. In this embodiment, the computer within vehicle 326 is programmed to download dealer boundary or “geo-fence” coordinates, and regularly monitors the vehicle GPS for when it intersects with those coordinates. In such fashion, the vehicle can “self-report” and initiate communication with dealership 300. Such operation can be controlled by the vehicle owner who can voluntarily opt-in or out of such an operation, and in this embodiment, communication with dealership computer 330 is initiated by vehicle 326 only if desired by the occupant of the vehicle. However, if opted in the driver may then be notified when in proximity of dealership 300 and vehicle 326 itself may provide an announcement communication seeking any messages from dealership 300 that may be personalized to the customer. The opt-in or out feature allows driver control of location information, preventing vehicle 326 from being tracked or regularly sending out its coordinates. Thus, only when a vehicle enters within a dealership boundary, and only if desired by the driver, will the vehicle be identified to the dealership.

Once the customer is identified, 330 computer sends information to computer 24 within vehicle 326 that is personalized to the customer. The personalized information is sent to the customer via the computer 24 and, as described above, may be via cellphone 206 or via audio/visual system 18. In addition, once vehicle 326 is determined to be in proximity to dealership 300, computer 330 is further programmed to send a notification to at least one of a service representative and a sales representative of dealership 330, or to another representative such as a receptionist. Computer 24 of vehicle 10 in one embodiment is configured to download a database of dealer coordinates that define to the vehicle when the vehicle is within proximity of the dealership. In such fashion, as vehicle 10 drives about, proximity to dealerships may be identified to occupants of the vehicle to offer the option of stopping in, or to notify of the proximity if driving to dealership 300.

Information that is personalized and sent to the customer is intended to enhance the customer experience with the dealership. Thus, vehicles equipped with the disclosed system may have any number of background experiences with the dealership and thus the communication to the vehicle is tailored to the vehicle detected. Such information may be presented as a computerized or pre-recorded voice message, as text, and/or as an icon (i.e., map) system to make any instructions clear to the recipient of the information.

In one example, the driver has previously arranged a service visit or appointment with the dealership. Thus, in this example, a welcome message may be sent to the vehicle with details of the scheduled service appointment (e.g., work that is scheduled to be performed), instructions where to park the vehicle (e.g., in service parking lot 308), instructions where to drop keys (e.g., in drop box 322, if the vehicle is being dropped off after business hours and when the dealership is closed for business), instructions where a replacement vehicle is positioned (e.g., may include a specific parking slot within one of the parking lots 304, 306, 308 which, as described, may be indoor parking lots), and access information for the replacement vehicle (e.g., if there is a lock box with a key or if the vehicle being used has a key already placed therein but the vehicle has a coded key entry). The instructions may also include information where to enter the facility during business hours, such as service entrance 320. Thus, for a service appointment, any number of instructions or information can be provided to the occupant of the vehicle, and the information is not limited to the examples above. Instead, any information may be provided that serves to enhance and provide a positive customer experience when dealing with the dealership.

In another example, the driver may have a previously scheduled sales appointment with the intention of meeting a sales representative for taking vehicles on test drives. In this case, the driver may be instructed to drive to the outdoor parking 306 that is designated for customer use that may be drive-up customers interested in purchasing a vehicle. Because the driver's intent is understood in this example, the driver may be directed to a convenient parking spot where the main entrance 316 is readily described and visible, such that the receptionist at 318 can be adequately prepared to issue a welcome to the prospective buyer and inform the sales representative in advance that the buyer is en route and will arrive shortly. If the buyer's intent is sufficiently understood in advance, then the personalized instructions may also be additionally tailored if the sales representative has, perhaps, set out specific vehicles for test drive. Thus, the instructions may include identifying specific vehicles and their locations that are proximate to the spot where the driver has been instructed to park, in order to enhance and provide a positive customer experience when dealing with the dealership.

In yet another example, the driver may be arriving unannounced to the dealership, but may have a previous relationship with the dealership, notes of which are maintained in the dealership computer database. For instance, in this example, a driver may be looking to simply browse vehicles or may be looking to talk with a service provider. Because the intent of the driver is not known, in this example, yet the vehicle is recognized when it passes into proximity of the dealership, a personalized message tailored to the driver may nevertheless be generated. For instance, the message may welcome back the driver (perhaps by name) and instruct the driver, to proceed to parking lot 308 if looking for service (and to enter service door 320), or to proceed to parking lot 306 and entrance 316, if looking to browse or purchase a vehicle. Yet additional personalized information may include, but is not limited, to instructions regarding whom to see as a sales representative, who is on duty, and whether their past representative is in the facility for the day or not. The instructions may further include information related to a past vehicle purchase, and/or information related to a past service experience, all in order to enhance and provide a positive customer experience when dealing with the dealership.

Thus, a system for managing an automobile dealership customer relationship is disclosed that includes a customer database 332 and a computer 330 programmed to identify a vehicle when the vehicle enters in proximity to a dealership, access the database and identify a customer that is affiliated with the identified vehicle, and send information to a computer within the vehicle that is personalized to the customer.

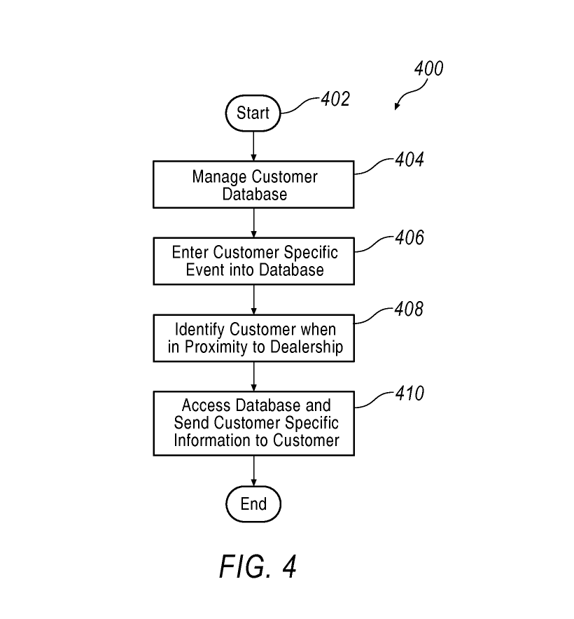

Referring to FIG. 4, a method of providing personalized dealership service 400 is therefore disclosed consistent with the above discussion. Starting at step 402, step 404 includes managing a customer database for an automobile dealership. Management of the database includes uploading data specific to a customer such that the database can be later accessed consistent with the above discussion. Such information may include past purchase information, vehicle service information, and such information may include a number of various vehicles. The information may be stored entirely within database 332, entirely in external database 28, or split therebetween. For instance, older and more historical data may be stored in computing device 28 such that the data may be more regionally accessible to other dealers, while data specific to one event may be stored locally on database 332. In such fashion, the overall experience of the customer may be enhanced because, if the driver enters a different dealership, the information may be available to help enhance the experience and provide improved customer service. Further, it is emphasized that such data is stored typically without revealing personally identifiable information (PII), such as social security number, family income, and the like. Rather, the system is geared toward proving an enhanced experience while providing assurance that such information cannot be obtained for nefarious purposes.

Once an event is planned (e.g., upcoming service or sales appointment), then at step 406 such customer-specific information is stored in database 332 and is readily accessible for when the driver enters in proximity to dealership 300. When the customer enters in proximity, at step 408, the customer or vehicle is identified, wherein communication is established between the vehicle and the dealership and a position of the vehicle is obtained via a GPS positioned on the vehicle. Communication is established via at least one of a WiFi system, an embedded modem in the vehicle, a cell phone in the vehicle, and a DSRC.

When vehicle 326 is identified as within the proximity of dealership 300, method 400 also may further comprise sending a notification to at least one of a service representative and a sales representative of the dealership. At step 410, database 332 is accessed and information is tailored specific to the vehicle or customer as identified. When the information is sent, it is provided to the occupant of the vehicle via at least one of an audio message on a sound system within the vehicle, an audio message on a cell phone within the vehicle, text to a visual system within the vehicle, and text to a cell phone. If the purpose of the visit is not known, information may be sent at step 410 as at least one of a welcome back message, information related to a past vehicle purchase, and information related to a past service experience. If the purpose is known, the personalized information may be sent to the customer to include information related to a previously scheduled appointment, such as a sales or a service appointment. If it is for a service appointment, the personalized information sent to the customer may include at least one of details of the scheduled service appointment, instructions where to park the vehicle, instructions where to drop keys, instructions where a replacement vehicle is positioned, and access information for the replacement vehicle.

Messages may be sent that are pre-scripted for off hours. A vehicle is detected within proximity of the dealership and, according to one embodiment, the proximity of the boundary may be referred to as a “geo-fence”. When the vehicle arrives, geo-fence information is sent to communication module or system 22 of vehicle 10, which may also be referred to as a SYNC module. Further, and in general, information sent to service or sales representatives upon customer arrival is sent via a tablet, smartphone, or desktop computer, as examples.

In one embodiment the dealer enters specific metadata into a back end system. This system could be centralized, and metadata can be entered that includes where the customer should park and how they can pick up their replacement vehicle as well as a keypad code to get into their replacement vehicle. This information will be entered at some point before the customer arrives at the dealership. The information will be sent to the customer's SYNC Module and Mobile Phone as soon as the customer arrives, and this information can be sent over WiFi. The customer will then be able to listen to the information using SYNC and view the information as text on their mobile phone. The dealer or a company employee will also use the back end system to create a geo-fence. This geo-fence will then be sent to the customer's SYNC module and/or mobile phone upon arrival. Once the SYNC module and/or mobile phone have received the geo-fence the SYNC Module and Mobile Phone will each use their GPS to compare their location with the geo-fence. Upon entering the geo-fence the SYNC module and or mobile phone will send a notification over WiFi to the dealership's backend system. That notification can then be sent to a Web Service and then to the Service Advisor System where a dealer could view that a customer has arrived.

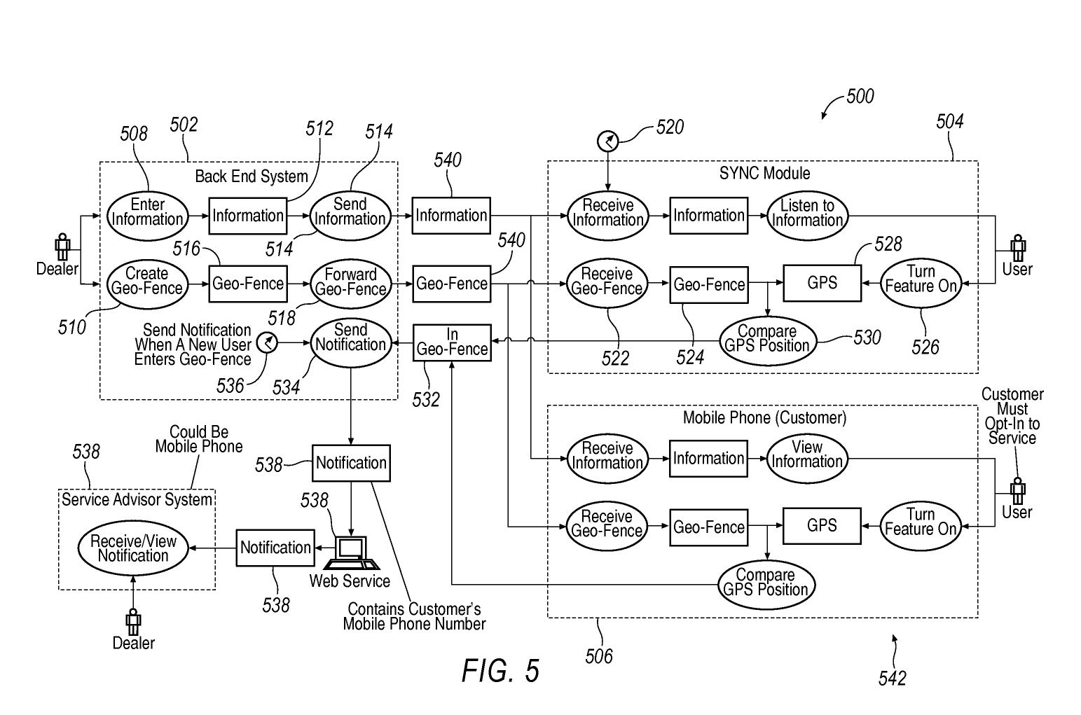

FIG. 5 illustrates a schematic representation of a system for providing personalized dealership service. System 500 illustrates a back end system 502, a SYNC module 504, and a mobile phone 506. Back end system 502 includes entering information 508, to include customer data and metadata that does not include PII, before the customer arrives. Back end system 502, in one embodiment, is centralized at a regional server, and, in another embodiment, general information is maintained in a regional server while information specific to the customer visit is entered and maintained on a server that is local to the dealership. Geo-fence is created 510, to include defining a boundary or distance from the dealership, which can include dealer contact and other information specific to the dealership. Information is maintained 512 and sent 514 when a customer/vehicle enters the geo-fence or within the established boundary. The geo-fence or boundary is maintained 516 and sent to the vehicle 518. The SYNC module 504 is maintained in the vehicle and configured to communicate with the back end system 502, as described above.

Upon arrival 520, SYNC module 504 receives geo-fence information 522 and the geo-fence is defined 524. The dealership feature is turned on 526 to let the dealership know when arriving, and SYNC module 504 establishes the GPS location 528. The GPS location is compared to the geo-fence 530 and, when within the geo-fence or established boundary 532, notification is sent 534 to back end system 502. If the user is a new user 536, then a new user notification is sent to the back-end to, for instance, notify a receptionist to prepare for the new user arrival. If the visit is scheduled, then notification is sent to the appropriate personnel 538. Also, and as summarized above, the appropriate geo-fence and appointment information is sent 540 to the user via the SYNC module. In addition or in the alternative, and as summarized above, notification to the user may also be provided via the user's cell phone 542, in which steps similar to those performed in the SYNC module may be performed in the cell phone, or in conjunction between the cell phone and the SYNC module. When a computer in the vehicle establishes communication with that of the dealership, it is typically to back end system 502 thereof.

The advantage of this solution is that a dealer will know exactly when a customer drives into the dealership parking lot and will be able to greet them. This adds a more personal element to the customer experience. The customer will also receive information on where to park and, if they need to get into a loaner vehicle, they will receive the keypad code.

In general, computing systems and/or devices, such as the processor and the user input device, may employ any of a number of computer operating systems, including, but by no means limited to, versions and/or varieties of the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OS X and iOS operating systems distributed by Apple Inc. of Cupertino, Calif., and the Android operating system developed by the Open Handset Alliance.

Computing devices generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, JavaScript, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system, such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above, or a NoSQL database such as MogoDB or Cassandra, as examples.

In some examples, system elements may be implemented as computer-readable instructions (e.g., software) on one or more computing devices (e.g., servers, personal computers, etc.), stored on computer-readable media associated therewith (e.g., disks, memories, etc.). A computer program product may comprise such instructions stored on computer-readable media for carrying out the functions described herein.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

1. A method, comprising:
managing a customer database for an automobile dealership;
identifying a customer in the database when a vehicle of the customer enters in proximity of the automobile dealership; and
providing information to the customer that is personalized to the customer.

2. The method of claim 1, wherein the proximity of the vehicle is determined with respect to the dealership via the steps of:
establishing communication between the vehicle and a computer located at the dealership; and
obtaining a position of the vehicle via a global positioning system (GPS) that is positioned in the vehicle.

3. The method of claim 2, wherein the step of establishing communication further comprises establishing communication via at least one of a WiFi system, an embedded modem in the vehicle, a cell phone in the vehicle, and a dedicated short-range communication (DSRC) system.

4. The method of claim 1, wherein, when the vehicle is identified as within the proximity of the dealership, the method further comprises sending a notification to at least one of a service representative and a sales representative of the dealership.

5. The method of claim 1, wherein the step of providing the information to the customer further comprises providing the information via at least one of:
an audio message on a sound system within the vehicle;
an audio message on a cell phone within the vehicle;
text to a visual system within the vehicle; and
text to the cell phone.

6. The method of claim 1, wherein the personalized information sent to the customer comprises at least one of:
a welcome back message;
information related to a past vehicle purchase; and
information related to a past service experience.

7. The method of claim 1, wherein the personalized information sent to the customer comprises information related to a previously scheduled appointment.

8. The method of claim 7, wherein the previously scheduled appointment is a sales appointment.

9. The method of claim 7, wherein the previously scheduled appointment is a service appointment, and wherein the personalized information sent to the customer comprises at least one of:
details of the scheduled service appointment;
instructions where to park the vehicle;
instructions where to drop keys;
instructions where a replacement vehicle is positioned; and
access information for the replacement vehicle.

10. A system for managing an automobile dealership customer relationship, comprising:
a customer database; and
a computer programmed to:
identify a vehicle when the vehicle enters in proximity to a dealership;
access the database and identify a customer that is affiliated with the identified vehicle; and
send information to a computer within the vehicle that is personalized to the customer.

11. The system of claim 10, wherein the computer is further programmed to:
establish communication with the vehicle via at least one of a WiFi system, an embedded modem in the vehicle, a cell phone in the vehicle, and a dedicated short-range communication (DSRC) system; and
obtain a position of the vehicle via a global positioning system (GPS) that is positioned in the vehicle.

12. The system of claim 10, wherein, once the computer identifies the vehicle in proximity to the dealership, the computer is further programmed to send a notification to at least one of a service representative and a sales representative of the dealership.

13. The system of claim 10, wherein the computer is further programmed to send the information to include at least one of:
a welcome back message;
information related to a past vehicle purchase; and
information related to a past service experience.

14. The system of claim 10, wherein the information personalized to the customer is related to a previously scheduled appointment that is one of a sales appointment and a service appointment.

15. The system of claim 14, wherein, when the previously scheduled appointment is a service appointment, the computer is further programmed to provide at least one of:
details of the scheduled service appointment;
instructions where to park the vehicle;
instructions where to drop keys;
instructions where a replacement vehicle is positioned; and
access information for the replacement vehicle.

16. An automobile dealership comprising:
a facility that provides automobile dealership services;
a customer database; and
a computer programmed to:
identify a vehicle when it enters in proximity to the facility;
access the database and identify a customer that is affiliated with the vehicle; and
send information to a computer within the vehicle that is personalized to the customer.

17. The dealership of claim 16, wherein the proximity of the automobile is defined as a fixed distance from the dealership that is delineated by a boundary that surrounds the dealership.

18. The dealership of claim 16, wherein the computer is further programmed to:
establish communication between the vehicle and the computer; and
determine a position of the vehicle via a global positioning system (GPS) that is positioned in the vehicle and via a computer within the vehicle.

19. The dealership of claim 18, wherein the information personalized to the customer is related to a previously scheduled appointment that is one of a sales appointment and a service appointment.

20. The dealership of claim 19, wherein, when the previously scheduled appointment is a service appointment, the computer is further programmed to provide at least one of:
details of the scheduled service appointment;
instructions where to park the vehicle;
instructions where to drop keys;
instructions where a replacement vehicle is positioned; and
access information for the replacement vehicle.
